(19) United States
(12) Patent Application Publication
(10) Pub. No.: US 2019/0102688 A1
(43) Pub. Date: Apr. 4, 2019

(54) METHOD, DEVICE AND SYSTEM FOR ESTIMATING CAUSALITY AMONG OBSERVED VARIABLES

(71) Applicant: NEC CORPORATION, Tokyo (JP)

(72) Inventors: Lu FENG, Beijing (CN); Chunchen LIU, Beijing (CN); Wenjuan WEI, Beijing (CN); Zheng PAN, Beijing (CN)

(73) Assignee: NEC CORPORATION, Tokyo (JP)

(21) Appl. No.: 16/141,174

(22) Filed: Sep. 25, 2018

(30) Foreign Application Priority Data
Sep. 30, 2017 (CN) 201710919294.1

(51) Int. Cl. G06N 5/04; G06F 17/15; G06N 5/02; G06N 7/00; G06F 17/18

(52) U.S. Cl. CPC G06N 5/04; G06F 17/15; G06F 17/18; G06N 7/005; G06N 5/022

(57) ABSTRACT

A method, device and system for estimating causality among observed variables are provided. The method for estimating causality among observed variables may include: in response to receiving expert knowledge for at least part of a plurality of observed variables, converting the expert knowledge into a constraint that needs to be satisfied by a causality objective function for the plurality of observed variables; and estimating the causality among the observed variables, by using observed data of the observed variables to optimally solve, through sparse causal reasoning, the causality objective function under a constraint of a directed acyclic graph and the constraint that needs to be satisfied and converted from the expert knowledge. With embodiments of the present disclosure, it is possible to incorporate the expert knowledge into the causal reasoning process in a simple manner to sufficiently utilize the expert knowledge and obtain a more precise causality.

### FIELD

The present disclosure relates to the technical field of data mining, and particularly to a method, device and system for estimating causality among observed variables.

### BACKGROUND

In the big data era, a large amount of data can be obtained in various data acquisition manners. Various types of useful information can be acquired through performing data analysis and mining on these data. However, in many application fields, only empirical understanding can be acquired because people cannot have a deep insight into the complicated underlying mechanism and operation process of the system but can only see the appearance of the system.

The causality structure learning focuses on restoring automatically the complicated underlying operation mechanism of the system and reproducing the data generation procedure based on observed data. At present, the causality structure learning technology has been already applied to multiple fields, such as pharmacy, manufacture, market analysis and the like, so as to have a deep insight into the essence of the system, further guide decision-making and create value. In the casual structure learning, various types of models may be employed, wherein commonly-used models include, for example, structural equation model, Boolean satisfiability causality model and Bayesian network causality model.

At present, most of causality discovery systems only restore system potential mechanisms based on observed data, or construct a causality network only based on expert knowledge and then test whether the data fits with a hypothesis model.

The reality is that we always have some expert knowledge, but it is not enough to construct the whole causal network.

In the article “Scoring and searching over Bayesian networks with causal and associative priors” (2012) by G. Bordoudakis and I. Tsamardions, International Conference on Machine Learning (ICML), it is proposed to use prior knowledge based on path confidence (soft constraints) and use a local greedy algorithm to perform causal reasoning. In this solution, the prior knowledge provided by the expert involves only a part of variable pairs, and is not one hundred percent sure. Furthermore, the prior knowledge might be incoherent confidence or mistaken priors. In this solution, a set of path confidences K=<R,Π> are input into a system, which denotes a probability that various paths exist between nodes, wherein R represents a path type, and Π represents a probability distribution. An element rᵢⱼ in R may be represented as follows:

rᵢⱼ ∈{⇒, ⇐, ⇔, [symbol] } (Formula 1)

wherein
⇒ represents that there exists a path from node i to node j between the node i and node j,
⇐ represents a path from node j to node i,
⇔ represents a bidirectional path existing between node i and node j, and [symbol]
represents that no any path exists between node i and node j.

In addition, the element Πᵣ_{ᵢⱼ} in Π represents a probability of a rᵢⱼ type path between node i and node j,

Πᵣ_{ᵢⱼ}= [symbol] π_{⇒}, π₁₁₁, π_{⇔}, π_{⇔} [symbol] (Formula 2)

In this solution, it is proposed to use the following scoring function:

P(G|D,J)∝P(D|G)P(G|J)

Sc(G|D,J)=Sc(D|G)+Sc(G|J) (Formula 3)

wherein:
G represents a causality map;
D represents observed data;
J denotes a joint distribution of path confidences, J=P(r₁, . . . , rₙ|Π)=P(R|Π);
Sc(D/|G) denotes a scoring function, which may be any existing scoring function for a Bayesian network, for example BDeu;

$$Sc ( G \vert J ) = log ( \frac{{J}_{{C}_{G}}}{{N}_{{C}_{G}}} )$$

denotes the score of the path confidences;
C denotes a joint instantiation of path variables R= [symbol] r₁, . . . , rₙ [symbol] ;

### J_{C}=P(R=C|Π); and

C_{G} denotes the joint instance of variable R in graph G.

It can be seen from the above scoring formula that the prior knowledge exists as an independent item of scoring to affect the searching process. For illustration purpose, FIG. 1 illustrates a flow chart of the method. As illustrated in FIG. 1, first a path confidences are set 101a, namely, K=<R,Π>. Then coherency detection is performed for the confidences in step 102, and if an incoherent confidence exists, perform pre-processing for K=<R,Π> to obtain the coherent confidence K′=<R,Π> (step 103). If all confidences are coherent, the process directly proceeds to step 104. In step 104, Jc value and Nc value (namely, the number of joint instances of the path variable R in graph G) are computed. Then a causality objective function is optimally solved using the observed data based on the greedy local search algorithm, and finally the causality structure is obtained.

Therefore, in the above solution, the prior knowledge is a set of confidence values, which means that the user needs to provide prior knowledge and its probability distribution for a group of paths. Although according to the solution, the system can permit errors to a certain degree, this system still requires the user to provide specific information such as probability, which is difficult for the user.

To this end, there is a need for new technology of causality discovery based on the expert knowledge.

### SUMMARY

In view of the above, the present disclosure provides a method, device and system for estimating causality among observed variables, to at least partially eliminate or alleviate problems in the prior art.

According to a first aspect of the present disclosure, there is provided a method for estimating causality among observed variables. The method may comprises: in response to receiving expert knowledge for at least part of a plurality of observed variables, converting the expert knowledge into a constraint that needs to be satisfied by a causality objective function for the plurality of observed variables; and estimating the causality among the observed variables, by using observed data of the observed variables to optimally solve, through sparse causal reasoning, the causality objective function under a constraint of a directed acyclic graph and the constraint that needs to be satisfied and converted from the expert knowledge.

According to a second aspect of the present disclosure, there is provided an apparatus for estimating causality among observed variables. The apparatus may comprise: an expert knowledge converting module and a causal reasoning module. The expert knowledge conversion module may be configured to, in response to receiving expert knowledge for at least part of a plurality of observed variables, convert the expert knowledge into a constraint that needs to be satisfied by a causality objective function for the plurality of observed variables. The causal reasoning module may be configured to estimate the causality among the observed variables by using observed data of the observed variables to optimally solve, through sparse causal reasoning, the causality objective function under a constraint of a directed acyclic graph and the constraint that needs to be satisfied and converted from the expert knowledge.

According to a third aspect of the present disclosure, there is provided a system for estimating causality among observed variables. The system may comprise: a processor, and a memory having a computer program code stored therein which, when executed by the processor, causes the processor to perform the method according to the first aspect of the present disclosure.

According to a fourth aspect of the present disclosure, there is provided a computer program product having a computer program code stored there which, when loaded into a computing device, cause the computing device to perform the method of the first aspect of the present disclosure.

In the embodiments of the present disclosure, it is possible to convert the expert knowledge into the constraint for the causality objection function, and thereby incorporate the expert knowledge into the causal reasoning process in a simple manner to sufficiently use the expert knowledge and obtain a more precise causality.

### BRIEF DESCRIPTION OF THE DRAWINGS

The above and other features of the present disclosure will become more apparent from the detailed description of embodiments illustrated with reference to the accompanying drawings, in which the same reference symbol represents the same element, wherein,

FIG. 1 illustrates a flow chart of an example method for estimating causality in the prior art;

FIG. 2 illustrates a flow chart of a method for estimating causality among observed variables according to an embodiment of the present disclosure;

FIG. 3 illustrates a block diagram of an apparatus for estimating causality among observed variables according to an embodiment of the present disclosure;

FIG. 4 illustrates a schematic diagram of an example implementation of an apparatus for estimating causality among observed variables according to an embodiment of the present disclosure; and

FIG. 5 illustrates a schematic diagram of a system for estimating causality among observed variables according to an embodiment of the present disclosure.

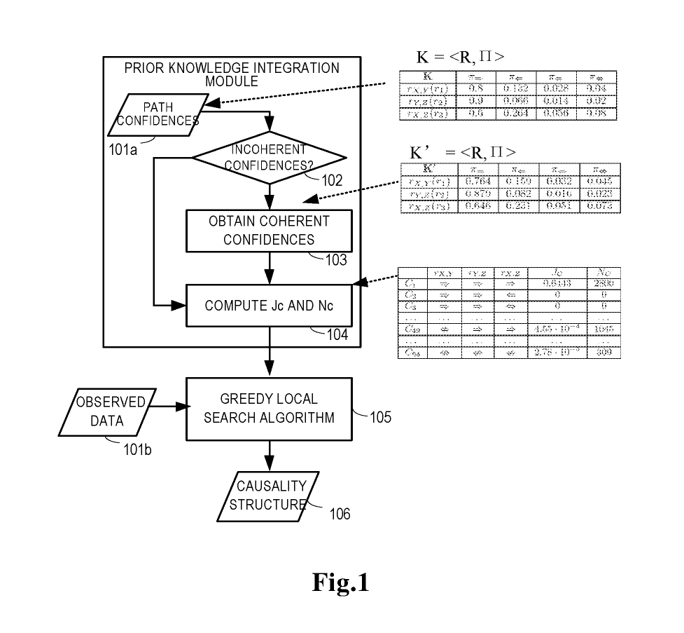

### DETAILED DESCRIPTION OF EMBODIMENTS

Various example embodiments of the present disclosure will be described below in detail with reference to the accompanied drawings. It would be appreciated that these drawings and description are merely provided as preferred example embodiments. It is noted that alternative embodiments of the structures and methods as disclosed herein are easily conceivable from the following description, and these alternative embodiments can be used without departing from the principles as claimed by the present disclosure.

It would be appreciated that description of these embodiments is merely to enable those skilled in the art to better understand and further implement example embodiments disclosed herein, and is not intended for limiting the scope disclosed herein in any manner. Besides, for the purpose of description, the optional steps, modules and the like are denoted in dashed boxes in the accompanying drawings.

As used herein, the terms “include/comprise/contain” and its variants are to be read as open-ended terms, which mean “include/comprise/contain, but not limited thereto.” The term “based on” is to be read as “based at least in part on.” The term “an embodiment” is to be read as “at least one example embodiment;” and the term “another embodiment” is to be read as “at least one further embodiment.” Relevant definitions of other terms will be given in the depictions hereunder.

As mentioned hereinabove, in the prior art the user needs to provide prior knowledge and its probability distribution for a group of paths so that a causal reasoning process can be performed based on expert knowledge. Although the system can permit errors to a certain degree, this system still requires the user to provide specific information such as probability, which is very difficult for the user. To this end, in the present disclosure is provided a new solution of incorporating expert knowledge in causality estimation. According to an embodiment of the present disclosure, it is proposed that the expert knowledge is converted into a constraint that needs to be satisfied by a causality objective function for the plurality of observed variables, thereby incorporating the expert knowledge into the causal reasoning process in a simple manner, to sufficiently utilize the expert knowledge.

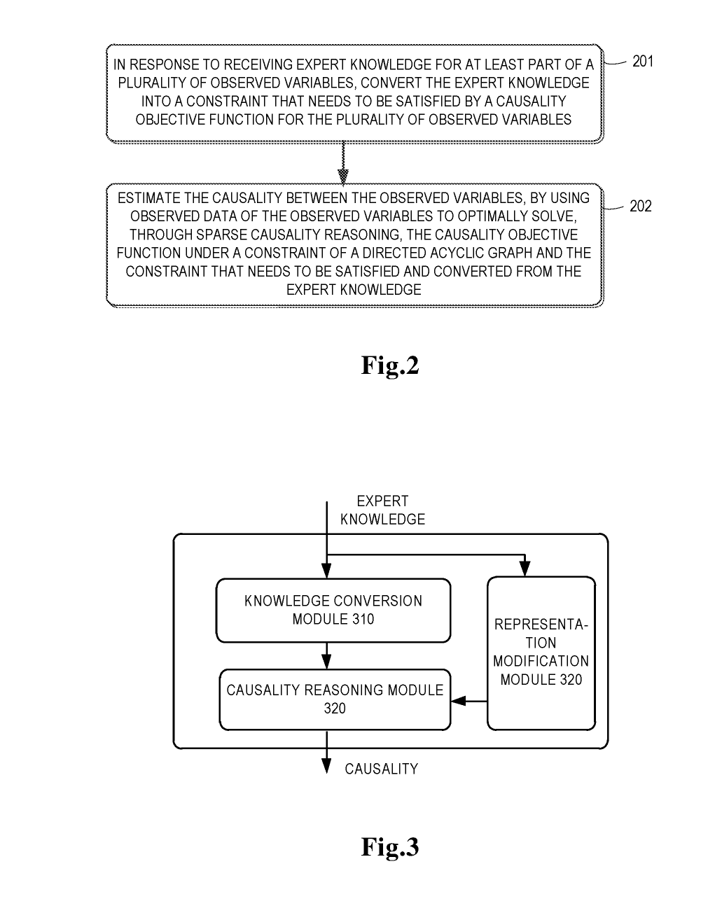

Hereinafter, reference will be made to FIG. 2 to FIG. 9 to describe the method, apparatus and system for causality estimation according to the present disclosure. However, it needs to be appreciated that these depictions are only for illustration purpose, and the present disclosure is not limited to details of these embodiments and figures.

FIG. 2 illustrates a flow chart of a method for estimating causality among observed variables according to an embodiment of the present disclosure. As illustrated in FIG. 2, first in step 201, the expert knowledge is converted into a constraint that needs to be satisfied by a causality objective function of the plurality of observed variables, in response to receiving expert knowledge for at least part of a plurality of observed variables.

An observation database can be set, which stores therein system observation data X, X ∈ R^{N×D}, where X is a matrix of N*D, N is a number of observation samples, and D is a dimension of the observed variable or a number of observed variables. Data in the observation database may be data from a third party or data collected in other manners. Moreover, the data can be pre-processed in advance, by preprocessing these data through such as integration, data reduction, noise reduction, and the like, of the original data. These preprocessing operations are known in the art, which will not be elaborated herein.

In addition, expert knowledge K is also received. It may determine the causality objective function through joint distribution of the observed data X and expert knowledge K:

P (G|X ,K)∝P (X|G)P (G|K) (Formula 4)

wherein,

$$P ( G \vert K ) = \{ \begin{matrix}0 & if G violates K \\ 1 & if G does not violate K\end{matrix}$$

To maximize the joint distribution, it may convert it into the following problem and perform an optimal solving:
Find a Directed Acyclic Graph DAG to satisfy:

$${G}^{*} ∈ {arg min}_{G} {\sum }_{d = 1}^{D} Score ( {x}_{d} , {x}_{{pa}_{d}} ) \qquad ( Formula 5 )$$

wherein
pa_{d} denotes a set of node number which denotes the parent set of the d^{th} node;
Score (x_{d}, xₚₐ_{_{d}}) may be a log likelihood value, namely, log p (x_{d}|xₚₐ_{_{d}}), or may employ any other proper scoring function,

G denotes the directed acyclic graph of the causality structure, and it is, for example, in the form of a matrix, G ∈ {0,1}^{D×D}, G_{d} denotes the d^{th} line of G, and “1”s in G_{d} denote positions of the parent nodes of the d^{th} node. In other words, the indices of “1”s in G_{d} denote a parent node set pa_{d}.

The expert knowledge may be constraints for at least part of the plurality of observed variables. These constraints for example may include any one or more of an edge constraint, a path constraint, a sufficient condition and an essential condition. Hereinafter, conversion of each type of expert knowledge will be described in detail for illustration purposes. However, it shall be appreciated that practical application may include any one or more of these expert knowledge, and furthermore, constraints for each type of expert knowledge may include any one or more types.

### Conversion of Edge Constraints

An edge constraint refers to a constraint imposed by the expert knowledge on an edge between nodes in the causality network, and it may involve a direct reason, no direct reason or a direct correlation.

### Direct Reason

As for a direct reason between two observed variables, it may be converted into a constraint for existence of parent-children relationship between two corresponding nodes.

For example, if node d′ is a direct reason of node d, it may determine that node d′ is the parent node of node d, whereupon it may convert the direct reason into: d′ ∈ pa_{d}, namely, d′ is an element in a parent node set of the node d.

### No Direct Reason

For no direct reason between two observed variables, it may be converted into a constraint for absence of parent-children relationship between the two corresponding nodes.

For example, if node d′ is not a direct reason of node d, it may determine node d′ is not the parent node of node d, whereupon it may convert the direct reason into: d′ ∉ pa_{d}, namely, d′ is not an element in the parent node set of the node d.

### Direct Correlation

A correlation relationship between two observed variables means that the two variables are the direct reason to each other. As such, it may convert it into a constraint for two corresponding nodes being in parent-children relationship to each other.

For example, if node d′ and node d are correlated to each other and there is an edge pointing to node d from node d′, namely, d′ [symbol] d, node d′ is a parent node of node d. If node d′ and node d are correlated to each other and there is an edge pointing to node d′ from node d, namely, d′ [symbol] d, node d is a parent node of node d′, d ∈ pa_{d′},

### Path Constraints

A path constraint refers to a constraint imposed by the expert knowledge on a path between nodes in the causality network, and it may involve an indirect reason, no indirect reason, an indirect correlation, or independence. For illustrative purposes, definitions of some expressions are introduced first.

Q_{d} denotes a set of nodes preceding the node d;
G_{Qd} denotes a sub-graph of graph G and is constructed of Q_{d} lines of the graph G;
f(G_{Qd}, d′) denotes a function which returns a set of children-grandchildren node d″ of node d′, the set of children-grandchildren node of d′ satisfying:
∀ d″ ∈ f (G_{Q,i}, d′), namely, there is a path from nodes d′ to d″.

Next, description will given to conversion of these types of path constraints including the indirect reason, the no indirect reason, the indirect correlation, or the independence.

### Indirect Reason

For an indirect reason, it is possible to convert the indirect reason between two observed variables into a constraint for the existence of parent-children relationship between any third point on the path between two corresponding nodes and an end point in the two corresponding nodes.

For example, if node d′ is an indirect reason of node d, namely, d′⇒d, it may find a subset C_{d′⇒d} of node d″ on the path between d′ and d, wherein C_{d′⇒d}⊆f (G_{Q}_{_{d}}, d′) ∪{d′}, and it is ensured that C_{d′⇒d} ⊆pa_{d}, C_{d′⇒d}≠∅.

As such, it may covert the indirect reason into a constraint for the existence of parent-children relationship between any third point d″ on the path between two corresponding nodes and node d.

### No Indirect Reason

For no indirect reason, it may convert the no indirect reason between two observed variables into a constraint for absence of parent-children relationship between any third point on the path between two corresponding nodes and an end point in the two corresponding nodes.

For example, if node d′ is not the indirect reason of node d, namely, d′≠>d, a node d″ on the path between nodes d′ and d is not the parent node of node d, namely,

d″ ∉ pa_{d}, ∀ d″ ∈ f (G_{Q}_{_{d}}, d′)∪ {d′}.

As such, it may covert the no indirect reason into a constraint for absence of parent-children relationship between any third point d″ on the path between two corresponding nodes and node d.

### Indirect Correlation

For an indirect correlation, it may convert the indirect correlation between two observed variables into an indirect reason between the two observed variables, and an indirect reason between a third observed variable other than the two observed variables and each of the two observed variables, and perform conversion therefor according to the scheme for conversion of the indirect reason.

For example, if node d′ and d are correlated, namely, d′⇔d, description will be made with d′ [symbol] d without loss of any generality. In the case of d′ [symbol] d, there exist two types of indirect correlation relationship:
1) Node d′ is an indirect reason of node d, i.e., d′⇒d;
2) There exists a third point d″ other than nodes d′ and d, which is an indirect reason of both node d′ and node d, namely, d″⇒d and d″⇒d′. As such, it is possible to convert the indirect correlation into a series of indirect reasons:

d′⇒d, d″⇒d, ∀d″ s.t. d″⇒d′

Further, it may perform conversion according the scheme for the above-mentioned indirect reason, to obtain the subset C_{d′⇒d} of the node d″, wherein,

$${C}_{{d}^{′} ⇔ d} ⊆ f ( {G}_{{Q}_{d}} , {d}^{′} ) ⋃ \{ {d}^{′} \} {⋃}_{∀ {d}^{″} s . t . {d}^{″} ⇒ {d}^{′}} ( f ( {G}_{{Q}_{d}} , {d}^{″} ) ⋃ \{ {d}^{″} \} )$$

and it shall ensure that C_{d′⇒d} ⊆pa_{d}, C_{d′⇒d}≠∅.

### Independence

Independence means that is no any correlation between two observed variables. Therefore, it is possible to convert the independence between two observed variables into no indirect reason between the two observed variables, and an indirect reason between the third observed variable other than the two observed variables and at most only one of the two observed variables, and perform conversion therefor according to the schemes for no indirect reason and the indirect reason.

For example, if node d′ and node d are independent, namely, d′⊥ d, description will be made with d′ [symbol] d without loss of generality. In the case of d′ [symbol] d, the following can be obtained:

d′@>d (1)

∀ d″s. t. d″⇒d′, d≠>d

Then, it is possible to convert the problem into a plurality of no indirect reason problems, thereby obtaining:

$${d}^{′′′} ∉ {pa}_{d} , \\ ∀ {d}^{′′′} ∈ f ( {G}_{{Q}_{d}} , {d}^{′} ) ⋃ \{ {d}^{′} \} {⋃}_{∀ {d}^{″} s . t . {d}^{″} ⇒ {d}^{′}} ( f ( {G}_{{Q}_{d}} , {d}^{″} ) ⋃ \{ {d}^{″} \} )$$

### Sufficient Condition

For a sufficient condition, it may convert a sufficient condition relationship between two observed variables into a direct reason between the two observed variables, and perform a conversion according to the scheme for the direct reason.

For example, if node d′ is a sufficient condition of node d, node d′ is the direct reason of node d, the direct reason may be then converted into a constraint for existence of parent-children relationship between the two corresponding nodes, d′ ∈ pa_{d}, namely, d′ is an element in a set of parent nodes of node d.

### Essential Condition

Regarding an essential condition, it may convert the essential condition between two observed variables into a constraint for pointing of the edge (if any) between the two corresponding nodes. For example, if node d′ is the essential condition of node d, it may be determined that between node d′ and node d, there might be an edge pointing from node d′ to node d.

In addition, it is also possible to adjust, based on the essential condition relationship between the two observed variables, representations of the two observed variables in the causality objective function. For example, it is possible to use the observed variable corresponding to node d′ to adjust the expression of the observed variable corresponding to node d.

For example, an original scoring expression may be

Score (x_{d}, xₚₐ_{_{d}}) (Formula 6)

In the case that node d′ is the essential condition of node d, the scoring expression may be modified as:

Score (x_{d}, dₚₐ_{_{d}}·x_{d′}) (Formula 7)

Through such adjustment, it is possible to take into consideration the essential condition for example in the scoring function.

Next, referring back to FIG. 2, in step 202, the causality among the observed variables is estimated by using the observed data of the observed variables to optimally solve, through sparse causal reasoning, the causality objective function under a constraint of the directed acyclic graph and the constraint that needs to be satisfied and converted from the expert knowledge.

The sparse causal reasoning may be performed in any appropriate manner, for example, it can be converted into an optimal causality sequence recursion solution problem. For example, it may be implemented based on A* search method. Regarding the solving of the optimal causality sequence recursion problem, it is already known in the art and will not be elaborated any more here.

In embodiments of the present disclosure, the expert knowledge may be incorporated, by converting it into the constraint that needs to be satisfied by the causality objective function of the plurality of observed variables, into the causal reasoning process in a simple manner to sufficiently utilize the expert knowledge and thereby obtain a more precise causality.

FIG. 3 illustrates a block diagram of an apparatus for estimating causality among observed variables according to an embodiment of the present disclosure. As illustrated in FIG. 3, the apparatus 300 comprises an expert knowledge conversion module 301 and a causal reasoning module 320. The expert knowledge conversion module 310 may be configured to, in response to receiving expert knowledge for at least part of a plurality of observed variables, convert the expert knowledge into a constraint that needs to be satisfied by a causality objective function of the plurality of observed variables. The causal reasoning module 320 may be configured to estimate the causality among the observed variables, by using observed data of the observed variables to optimally solve, through sparse causal reasoning, the causality objective function under a constraint of a directed acyclic graph and the constraint that needs to be satisfied and converted from the expert knowledge.

The expert knowledge may comprise any one or more of an edge constraint, a path constraint, a sufficient condition and an essential condition.

In an embodiment of the present disclosure, the expert knowledge conversion module 310 may be configured to perform, for the edge constraint, at least one of converting a direct reason between two observed variables into a constraint for existence of parent-children relationship between two corresponding nodes; converting no direct reason between two observed variables into a constraint for absence of parent-children relationship between two corresponding nodes; and converting a direct correlation between two observed variables into a constraint for two corresponding nodes being in parent-children relationship to each other.

In another embodiment of the present disclosure, the expert knowledge conversion module 310 may be configured to perform, for the path constraint, at least one of: converting an indirect reason between two observed invariables into a constraint for existence of parent-children relationship between any third point on the path between two corresponding nodes and an end point in the two corresponding nodes; converting no indirect reason between two observed variables into a constraint for absence of parent-children relationship between any third point on the path between two corresponding nodes and an end point in the two corresponding nodes; converting an indirect correlation between two observed variables into an indirect reason between the two observed variables, and indirect reasons between a third observed variable other than the two observed variables and each of the two observed variables, and converting them based on the converting the indirect reason; and converting independence between two observed variables into no indirect reason between the two observed variables, and an indirect reason between a third observed variable other than the two observed variables and at most one of the two observed variables, and converting them based on the converting the no indirect reason and the converting the indirect reason.

In a further embodiment of the present disclosure, the expert knowledge conversion module 310 may be configured to, for the sufficient condition, convert a sufficient condition relationship between two observed variables into a direct reason between the two observed variables, and converting it based on the converting the direct reason.

In a further embodiment of the present disclosure, the expert knowledge conversion module 310 is configured to, for the essential condition, convert an essential condition relationship between two observed variables into a constraint for pointing of an edge between two corresponding nodes.

It shall be appreciated that for details of the expert knowledge conversion, reference may be made to the above depictions of the content related to step 201 of the method described hereinabove.

In addition, in a further embodiment of the present disclosure, the apparatus 300 further comprises a representation adjusting module 330 configured to modify, based on an essential condition relationship between two observed variables, an expression of corresponding observed variables in the causality objective function. For detailed operations, please refer to depictions related to “essential conditions” with refer to the method.

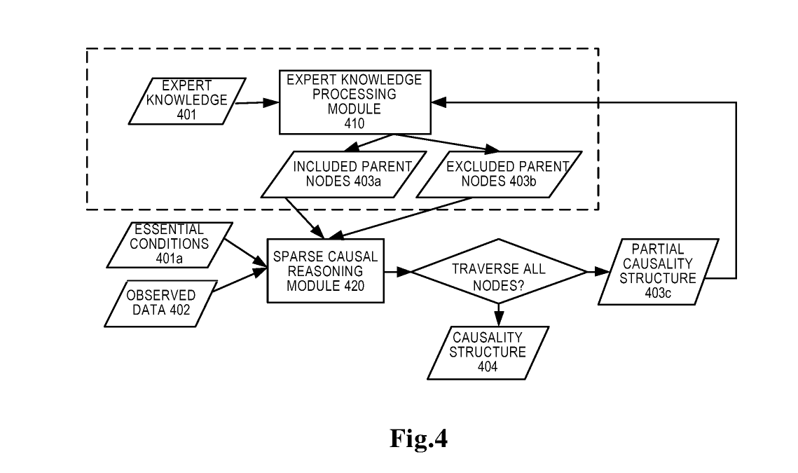

For illustration purposes, reference is made to FIG. 4 to describe an example implementation of an apparatus for estimating causality among observed variables according to an embodiment of the present disclosure.

As illustrated in FIG. 4, an expert knowledge processing module 410 receives expert knowledge 401. As described above, the expert knowledge may comprise any one or more of an edge constraint, a path constraint, a sufficient condition and an essential condition. The expert knowledge processing module 410 may perform, according to the abovementioned conversion ways, corresponding processing based on types of different expert knowledge, to convert it a parent node constraint (included parent nodes 403a), non-parent node constraint (excluded parent nodes 403b), and so on. The included parent nodes 403a and excluded parent nodes 403b for example may be obtained based on various constraints converted from edge constraints, path constraints, sufficient conditions and essential conditions. These constraints include, for example, a constraint for existence of parent-children relationship between the two corresponding nodes, a constraint for absence of parent-children relationship between the two corresponding nodes, a constraint for existence of parent-children relationship between a third point and an end point in the two corresponding nodes, a constrain for absence of parent-children relationship between a third point and an end point in the two corresponding nodes and a constraint for pointing of an edge, and so on. In addition, as for the essential conditions 401a in the expert knowledge, it is further possible to modify, based thereon, the causality objective function used in a sparse causal reasoning module, as stated above, to enable it to reflect the essential condition relationship.

The sparse causal reasoning module 420 may use observed data 402 to solve the causality objective function based on a sparse causal reasoning algorithm. The sparse causal reasoning for example may employ A* search and its various improvements and extended algorithms. As illustrated in FIG. 4, during each of recursion solving, it is possible to return the obtained partial causality structure to the expert knowledge processing module, so that the generated parent node relationship constraints 403a and 403b can be more effectively used to constrain the causality objective function. For example, it is possible to determine, based on the partial causality structure, the third point on the path between two corresponding nodes so that the constraints are more specific. It shall be appreciated that it is favorable to return the local casual structure relationship for a partial causal reasoning method such as A* search, and it is possible not to return the partial causality structure relationship for a portion of causal reasoning algorithms supporting complicated constraints.

After the sparse causal reasoning module already traverses all nodes, the obtained causality structure 404 may be output as the resulting causality among observed variables.

It is to be appreciated that FIG. 4 is only presented for illustration purposes. The present disclosure is not limited to various details illustrated herein, and various changes may be made according to practical applications.

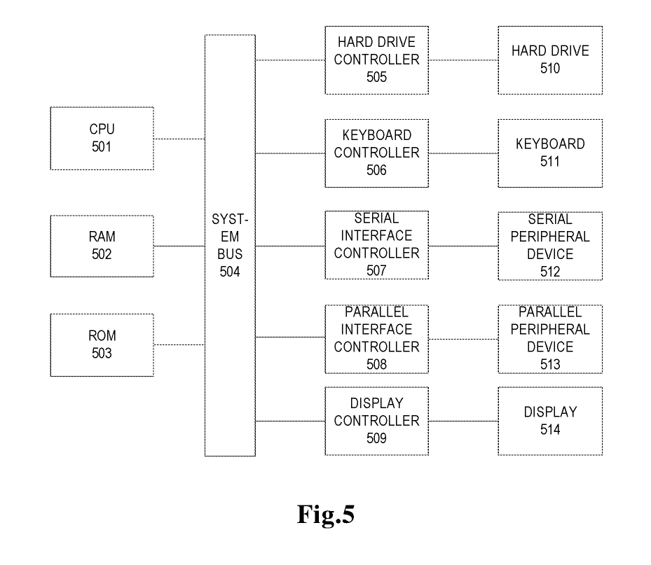

Furthermore, FIG. 5 schematically illustrates a diagram of a system for estimating causality among observed variables according to an embodiment of the present disclosure. Hereunder, reference will be made to FIG. 5 to describe the system that may implement estimation of the causality according to the present disclosure.

The computer system as illustrated in FIG. 5 includes a Central Processing Unit (CPU) 501, a Random Access Memory (RAM) 502, a Read Only Memory (ROM) 503, a system bus 504, a hard disk controller 505, a keyboard controller 506, a serial interface controller 507, a parallel interface controller 508, a display controller 509, a hard disk 510, a keyboard 511, a serial peripheral device 512, a parallel peripheral device 513 and a display 514. Among these components, connected to the system bus 504 are the CPU 501, the RAM 502, the ROM 503, the hard disk controller 505, the keyboard controller 506, the serial interface controller 507, the parallel interface controller 508 and the display controller 509. The hard disk 510 is connected to the hard disk controller 505; the keyboard 511 is connected to the keyboard controller 506; the serial peripheral device 512 is coupled to the serial interface controller 507; the parallel peripheral device 513 is coupled to the parallel interface controller 508; and the display 514 is coupled to the display controller 509.

The memory may store one or more codes therein which, when executed by the computer, causes the CPU to perform steps of the method for estimating causality among observed variables as proposed in the embodiments of the present disclosure, for example those steps of the method as described above with reference to FIG. 2.

It shall be appreciated that the structural block diagram of FIG. 5 is only provided for illustration purposes, and the present disclosure is not limit thereto. In some cases, it is possible to add some devices thereto or reduce some devices therefrom according to requirements.

It would be further appreciated that the solution as proposed in the present disclosure can be used in various applications such as pharmacy, manufacture, market analysis, traffic prediction, weather forecast, air quality prediction and the like, to produce advantageous effects.

In addition, the embodiments of the present disclosure can be implemented by software, hardware or a combination of software and hardware. The hardware portion can be implemented using a dedicated logic; and the software portion can be stored in the memory and executed by an appropriate instruction executing system, for example a microprocessor or dedicated design hardware.

Those skilled in the art would appreciate that the foregoing method and device can be implemented using a computer executable instruction and/or a control code contained in the processor, and for example, such code is provided on a carrier medium such as a disk, a CD or DVD-ROM, a programmable memory such as a read only memory (firmware), or a data carrier such as an optical or electronic signal carrier.

The device and components thereof in the present embodiment can be implemented by a hardware circuit such as a large-scale integrated circuit or gate array, a semiconductor such as a logic chip, transistor and the like, or a programmable hardware device such as a field programmable gate array, programmable logic device and the like, or can be implemented by software executed by various types of processors, or can be implemented by a combination of the above hardware circuit and software, for example firmware.

Although the present disclosure has been described with reference to the currently envisioned embodiments, it should be understood that the present disclosure is not limited to the disclosed embodiments. By contrast, the present disclosure is intended to cover various modifications and equivalent arrangements included in the spirit and scope of the appended claims. The scope of the appended claims meets the broadest explanations to cover all such modifications and equivalent structures and functions.

1. A method for estimating causality among observed variables, comprising:
in response to receiving expert knowledge for at least part of a plurality of observed variables, converting the expert knowledge into a constraint that needs to be satisfied by a causality objective function for the plurality of observed variables; and
estimating the causality among the observed variables, by using observed data of the observed variables to optimally solve, through sparse causal reasoning, the causality objective function under a constraint of a directed acyclic graph and the constraint that needs to be satisfied and converted from the expert knowledge.

2. The method of claim 1, wherein the expert knowledge comprises any one or more of an edge constraint, a path constraint, a sufficient conditions and an essential condition.

3. The method of claim 2, wherein the method further comprises performing, for the edge constraint, at least one of:
converting a direct reason between two observed variables into a constraint for existence of parent-children relationship between two corresponding nodes;
converting no direct reason between two observed variables into a constraint for absence of parent-children relationship between two corresponding nodes; and
converting a direct correlation between two observed variables into a constraint for two corresponding nodes being in parent-children relationship to each other.

4. The method of claim 2, wherein the method further comprises performing, for the path constraint, at least one of:
converting an indirect reason between two observed invariables into a constraint for existence of parent-children relationship between any third point on the path between two corresponding nodes and an end point in the two corresponding nodes;
converting no indirect reason between two observed variables into a constraint for absence of parent-children relationship between any third point on the path between two corresponding nodes and an end point in the two corresponding nodes;
converting an indirect correlation between two observed variables into an indirect reason between the two observed variables and indirect reasons between a third observed variable other than the two observed variables and each of the two observed variables, and converting them based on the converting the indirect reason; and
converting independence between two observed variables into no indirect reason between the two observed variables and an indirect reason between a third observed variable other than the two observed variables and at most one of the two observed variables, and converting them based on the converting the no indirect reason and the converting the indirect reason.

5. The method of claim 2, wherein the method further comprises: for the sufficient condition, converting a sufficient condition relationship between two observed variables into a direct reason between the two observed variables, and converting it based on the converting the direct reason.

6. The method of claim 2, wherein the method further comprises: for the essential condition, converting an essential condition relationship between two observed variables into a constraint for pointing of an edge between two corresponding nodes.

7. The method of claim 2 or 3, further comprising: modifying based on an essential condition relationship between two observed variables, an expression of corresponding observed variables in the causality objective function.

8. An apparatus for estimating causality among observed variables, comprising:
an expert knowledge conversion module configured to, in response to receiving expert knowledge for at least part of a plurality of observed variables, convert the expert knowledge into a constraint that needs to be satisfied by a causality objective function for the plurality of observed variables; and
a causal reasoning module configured to estimate the causality among the observed variables, by using observed data of the observed variables to optimally solve, through sparse causal reasoning, the causality objective function under a constraint of a directed acyclic graph and the constraint that needs to be satisfied and converted from the expert knowledge.

9. The apparatus of claim 8, wherein the expert knowledge comprises any one or more of an edge constraint, a path constraint, a sufficient condition and an essential condition.

10. The apparatus of claim 9, wherein the expert knowledge conversion module is further configured to perform, for the edge constraint, at least one of:
converting a direct reason between two observed variables into a constraint for existence of parent-children relationship between two corresponding nodes;
converting no direct reason between two observed variables into a constraint for absence of parent-children relationship between two corresponding nodes; and
converting a direct correlation between two observed variables into a constraint for two corresponding nodes being in parent-children relationship to each other.

11. The apparatus of claim 9, wherein the expert knowledge conversion module is configured to perform for the path constraint, at least one of:
converting an indirect reason between two observed invariables into a constraint for existence of parent-children relationship between any third point on the path between two corresponding nodes and an end point in the two corresponding nodes;
converting no indirect reason between two observed variables into a constraint for absence of parent-children relationship between any third point on the path between two corresponding nodes and an end point in the two corresponding nodes;
converting indirect correlation between two observed variables into an indirect reason between the two observed variables and indirect reasons between a third observed variable other than the two observed variables and each of the two observed variables, and converting them based on the converting the indirect reason; and
converting independence between two observed variables into no indirect reason between the two observed variables and an indirect reason between a third observed variable other than the two observed variables and at most one of the two observed variables, and converting them based on the converting the no indirect reason and the converting the indirect reason.

12. The apparatus of claim 9, wherein the expert knowledge conversion module is configured to, for the sufficient condition, convert a sufficient condition relationship between two observed variables into a direct reason between the two observed variables, and converting it based on the converting the direct reason.

13. The apparatus of claim 9, wherein the expert knowledge conversion module is configured to, for the essential condition, convert an essential condition relationship between two observed variables into a constraint for pointing of an edge between two corresponding nodes.

14. The apparatus of claim 9, further comprising a representation modification module configured to modify, based on an essential condition relationship between two observed variables, an expression of the corresponding observed variables in the causality objective function.

15. A system for estimating causality among observed variables, comprising:
a processor, and
a memory having a computer program code stored therein which, when executed by the processor, causes the processor to perform the method according to claim 1.

16. The method of claim 3, further comprising: modifying based on an essential condition relationship between two observed variables, an expression of corresponding observed variables in the causality objective function.
